(19) United States
(12) Patent Application Publication
(10) Pub. No.: US 2004/0093424 A1
(43) Pub. Date: May 13, 2004

(54) Packet routing device

(76) Inventor: Kozo Kojima, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/701,944

(22) Filed: Nov. 5, 2003

(30) Foreign Application Priority Data
Nov. 5, 2002 (JP) 2002-321272

(51) Int. Cl. G06F 15/16

(52) U.S. Cl. 709/232; 709/238

(57) ABSTRACT

Each of packet processing units (PMs) provided in a router, in the case of receiving a packet received at a receipt port, searches, as a receiving-side PM, for a corresponding transmitting-side PM by use of a receiving-side VPN identifier of the packet, on the other hand, in the case of receiving the packet from the receiving-side packet processing unit, searches, as a transmitting-side PM, for a transmission port of the packet by use of a transmitting-side VPN identifier of the packet, and forwards the packet to the transmission port searched for.

### BACKGROUND OF THE INVENTION

The invention relates to a packet routing device and particularly to a technology of routing a packet in communications between Virtual Private Networks (VPNs) through a search process by each packet management (PM) unit on a receiving side and on a transmitting side.

Hitherto, a router system is, as shown in FIG. 7A, constructed of a switching unit (SW) and a plurality of PMs (which might be called “blades” to the SW) connected to the SW. The SW has a control processor and a switching function. Further, each of the PMs has a termination processing function of a Layer 2 (L2) and a routing function of a Layer 3 (L3).

In recent years, the router system has a function of performing routing related to VPN communications between a user terminal and a predetermined Internet Service Provider (ISP). Further, the router system has a function of accommodating a plurality of VPNs and actualizing communications between VPNs. Moreover, a certain router system functions as a device which is called Broadband Remote Access Server (BRAS) that is placed at a edge of core network (e.g. Internet Protocol (IP) network) and connects each user terminal accommodated directly at an access side to a variety of broadband services provided on a core network side (an up-link side). The BRAS performs, in order to provide the broadband services provided by a variety of servers (e.g. contents server) to users belonging to one of VPNs, packet routing between a VPN of an user and another VPN of a target server of the user. Therefore, a function of actualizing the communications between the VPNs is substantially indispensable for the BRAS.

One of router system actualizes the packet routing related to the VPN communications by executing a search process in each PM on a receiving side and a transmitting side of packets. Each PM functions as a receiving-side PM when receives a packet received at a receipt port and functions as a transmitting-side PM when receives a packet from other PM as the receiving-side PM via the SW. Each PM as the receiving-side PM executes a search process for the transmitting-side PM corresponding to a destination of the packet from the receipt port, and forwards the packet to the transmitting-side PM searched for. On the other hand, each PM as the transmitting-side PM executes a search process for searching a transmission port of the packet, and forwards the packet to the transmission port searched for.

The BRAS router system, each PM executing the search process, as shown in FIGS. 7B and 7C, has two routing tables which respectively includes entries for searching for network addresses and entries for searching for the terminals per PM. The entries for searching for the terminals are used for routing each packet of which a destination is a user's terminal. The routing table of each PM retains the entries of the same contents. Each routing table has entries each including a VPN identifier (VPN-ID), an IP destination address (IPDA) and a prefix. Each PM searches for a VPN-ID corresponding to the receipt port of the packet (receiving-side VPN-ID), and a transmitting-side PM and a transmission port corresponding to the IPDA of the packet and the prefix by use of the routing table.

The entries in the routing table are normally registered in a Content Addressable Memory (CAM) device. The number of entries registered in the CAM device depends on a capacity of the CAM device. It is therefore desirable that the CAM entries be efficiently registered by an aggregation of the entries, and so on.

Herein, there were the following problems in the prior art. That is, in the search process by each PM, the receiving-side VPN-ID is used as a search key to the routing table. Therefore, when the router system transmits to the same egress route (transmission port) packets received from the different VPNs (the receiving-side VPN is different), the same entries for the terminals had to be prepared per the receiving-side VPN. For example, in FIG. 7A, in case each of an ISP-A (VPN-A) and a server C (VPN-C) transmits packets to each terminal of a terminal group A, entries for the terminals corresponding to the VPN-A (self-VPN) and the entries for the terminals corresponding to the VPN-C (other VPN) had to be registered in the routing table. Thus, in the prior art, the overlapped entries for the terminals had to be registered to the routing table each time the number of VPNs that is performed communications between the VPNs increases.

Further, prior art document information related to the invention of the application is given as follows.

Japanese Patent Application Laid-Open Publication No.2002-111723

### SUMMARY OF THE INVENTION

One of object of the invention is to provide a packet routing device enabling an efficient entry registration without registering an overlapped entry.

The invention adopts the following architecture for accomplishing the object.

The invention is a packet routing device accommodating a plurality of virtual private networks (VPNS), comprising a switch and a plurality of packet processing units, wherein each packet processing unit, in the case of receiving a packet received at a receipt port, searches, as a receiving-side packet processing unit, for a transmitting-side packet processing unit for forwarding this packet to a transmission port from a routing table by use of a receiving-side VPN identifier of the packet, and forwards the packet to a packet processing unit corresponding to the transmitting-side packet processing unit, and, in the case of receiving the packet via the switch from the receiving-side packet processing unit, searches, as a transmitting-side packet processing unit, for a transmission port for this packet from the routing table by use of a transmitting-side VPN identifier of the packet, and forwards the packet to the transmission port searched for.

According to the invention, the receiving-side packet processing unit effects the routing search by use of the receiving-side VPN identifier, and the transmitting-side packet processing unit effects the routing search by use of the transmitting-side VPN identifier. Namely, the invention has no such bad effect as to register the overlapped entry in order to perform the routing search by use of the receiving-side VPN identifier in the receiving-side and transmitting-side side packet processing units. Namely, the overlapped registration of the entry can be prevented. Accordingly, for instance, in the case where the packet routing device accommodates the terminal device belonging to the VPN, it may be sufficient if the entries for the terminals are not prepared for every receiving-side VPN, and therefore the efficient entry registration can be done.

A router and a layer-3 switch each having the switch and the plurality of packet processing units can be exemplified as the packet routing devices.

It is preferable that the invention be constructed so that each of the packet processing units, in the case of functioning as the receiving-side packet processing unit, searches for the corresponding transmitting-side packet processing unit and transmitting-side VPN identifier from the routing table by use of the receiving-side VPN identifier, and forwards the thus-searched transmitting-side VPN identifier to the transmitting-side packet processing unit, and, in the case of functioning as the transmitting-side packet processing unit, searches for the corresponding transmission port from the routing table by use of the transmitting-side VPN identifier from the receiving-side packet processing unit.

It is preferable that the packet routing device of the invention be constructed so that it further comprises entry registering means for executing a process of registering the entry in the routing table of each packet processing unit, the entry registering means receives a plurality of entries as candidates for registration with respect to a certain packet processing unit, each entry contains the VPN identifier as a search key, and packet processing unit identifying information and a transmitting-side VPN identifier that correspond to that VPN identifier, the entry registering means executes a process for registering in the routing table only such an entry that among the plurality of entries as the candidates for registration, the packet processing unit identifying information contained in the entry indicates the certain packet processing unit, and that the VPN identifier as the search key is the same as the transmitting-side VPN identifier.

If done in this way, it is possible to prevent such a state that the overlapped entry is to be registered in the routing table.

Further, the invention can be also specified as a packet routing device disposed between a network side and a user side, accommodating a plurality of virtual private networks (VPNs), accommodating a user terminal belonging to any one of the plurality of VPNs, the device comprising a switch and a plurality of packet processing units, wherein each packet processing unit, in the case of receiving a packet received at a receipt port and addressed to the user terminal, searches, as a receiving-side packet processing unit, for a transmitting-side packet processing unit and a transmitting-side VPN identifier that correspond to a receiving-side VPN identifier and a destination network address of the packet from a routing table, and, in the case of receiving the packet and the transmitting-side VPN identifier from the receiving-side packet processing unit via the switch, searches, as a transmitting-side packet processing unit, for a transmission port corresponding to the transmitting-side VPN identifier and to a destination host address of the packet from the routing table, and forwards the packet to the transmission port searched for.

Moreover, the invention can be specified as a packet processing device provided in a packet routing device accommodating a plurality of virtual private networks (VPNs) with at least one other packet processing device, comprising a receiving-side packet processing unit, a transmitting-side packet processing unit and a routing table, wherein the receiving-side packet processing unit receives a packet received at a receipt port of the packet routing device and searches for other packet processing device for forwarding this packet to a transmission port from the routing table by use of a receiving-side VPN identifier of this packet, and the transmitting-side packet processing unit receives a packet forwarded from other packet processing device and searches for a transmission port of this packet from the routing table by use of a transmitting-side VPN identifier of this packet.

### BRIEF DESCRIPTION OF THE DRAWINGS

FIGS. 1A and 1B show a compositions view for explaining an embodiment of a packet routing device;

FIG. 2 shows a compositions view for explaining an embodiment of a packet processing unit (packet processing device: corresponding to PM);

FIG. 3A is a diagram showing a data structure example of a table for searching for a receiving-side VPN identifier;

FIG. 3B is a diagram showing a data structure example of a routing table for searching for a transmitting-side packet processing unit and a transmitting-side VPN identifier;

FIG. 4 is a flowchart showing a process by the packet processing unit;

FIG. 5 is a flowchart showing an entry delete process when registering an entry;

FIGS. 6A and 6B are an operation explanatory diagram of the entry delete process;

FIGS. 7A, 7B and 7C are an explanatory view of the prior art.

### DESCRIPTION OF THE PREFFERD EMBODIMENT

Embodiments of the invention will hereinafter be explained with reference to the drawings. Compositions of the embodiment are exemplifications, and the invention is not limited to the compositions of the embodiment.

<Compositions of Packet Routing Device>

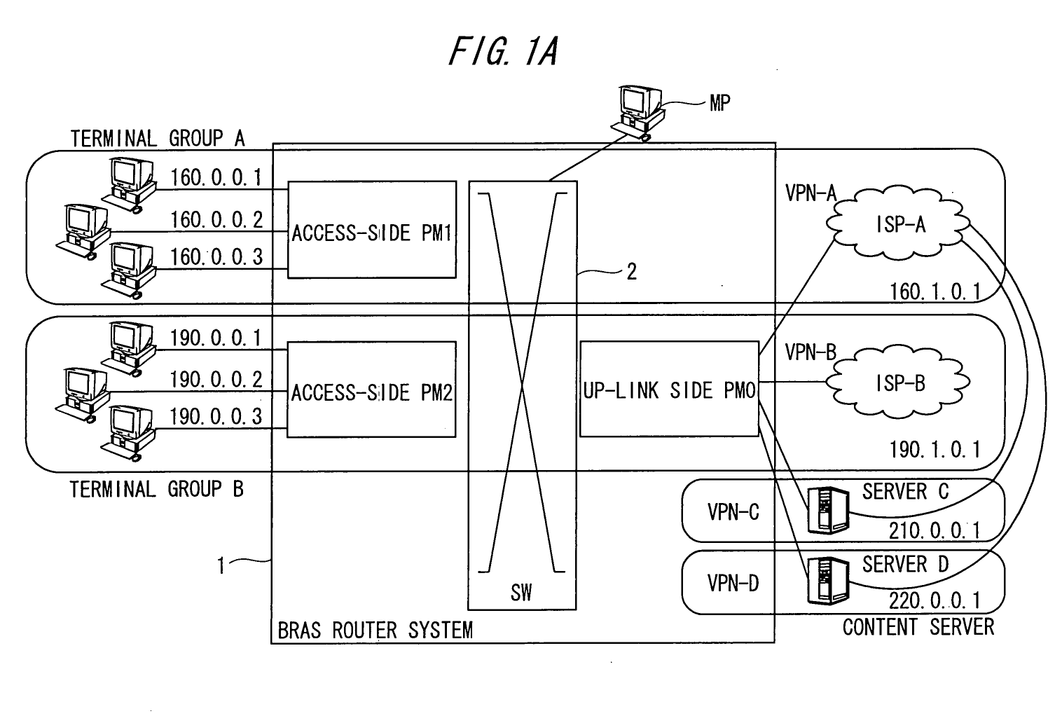

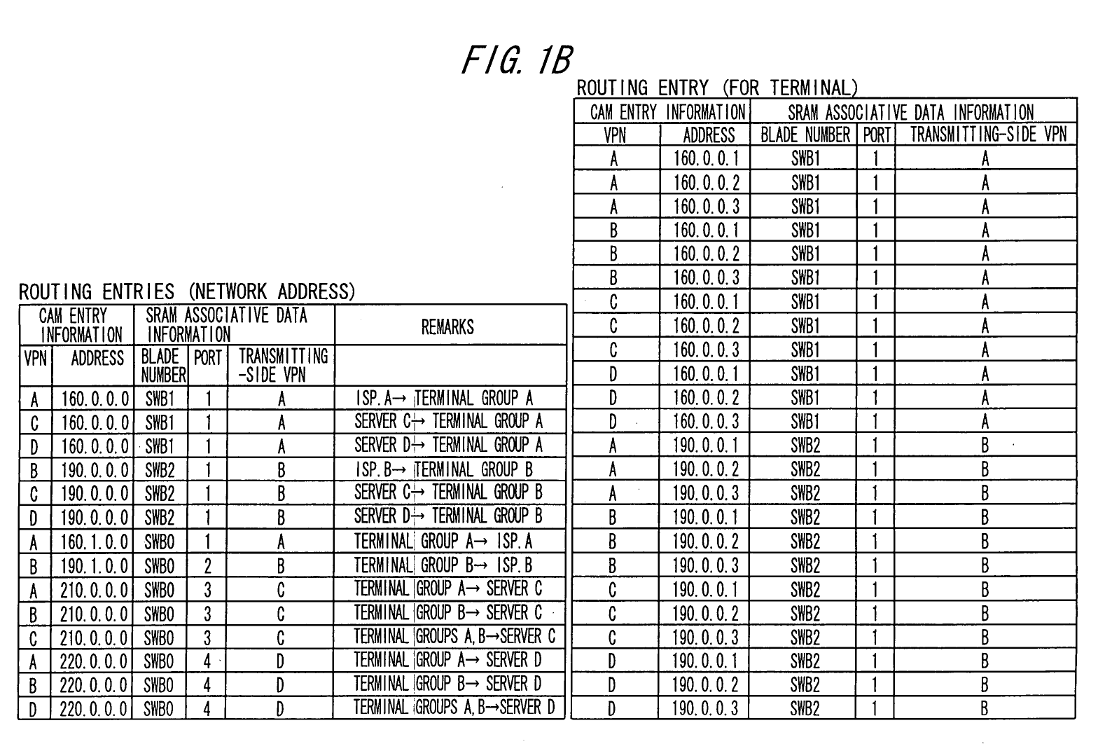

FIGS. 1A and 1B are diagrams showing an embodiment of a system composition of a packet routing device of the invention. In FIG. 1A, a BRAS router system 1 (which will hereinafter be referred to as a “router 1”) corresponding to the packet routing device of the present invention is shown.

The router 1 includes a switch (SW 2) and a plurality of packet processing units PM0, PM1 and PM2 (corresponding to a packet processing device, a receiving-side packet processing unit and a transmitting-side packet processing unit). The packet processing unit PM1 (which will hereinafter be simply termed a “PM1”) is a PM on an access side (a down-link side or a user side), and accommodates user's terminals in a group A belonging to a VPN-A. In FIG. 1, the PM accommodates, by way of an example, a plurality of terminals having IP addresses “160.0.0.1 ”, “160.0.0.2”, “160.0.0.3”, respectively.

Further, the packet processing unit PM2 (which will hereinafter be simply termed a ┌PM2┘) is a PM on the access side and accommodates user's terminals in a group B belonging to a VPN-B. In FIG. 1A, the PM2 accommodates, by way of an example, a plurality of terminals having IP addresses “190.0.0.1 ”, “190.0.0.2 ”, “190.0.0.3”, respectively.

Moreover, the packet processing unit PM0 (which will hereinafter be simply termed a ┌PM0┘) is a PM on the up-link side (a network side) and is connected via a core network (an IP network: not illustrated) to an ISP-A (an IP address “160.1.0.1”) belonging to the VPN-A, an ISP-B (an IP address “190.1.0.1”) belonging to the VPN-B, a server C (an IP address “210.0.0.1”) belonging to a VPN-C and a server D (an IP address “220.0.01”) belonging to a VPN-D.

The servers C and D are, for instance, content servers. Each terminal in the group A and B is able to access the servers C and D and to download data from them. Each of the servers C and D, further, can also function as routing servers for routing packets respectively between, the ISP-A, each terminal in the group A, the ISP-B and each terminals in the group B.

Thus, the router 1 accommodates the plurality of VPNs (VPN-A, VPN-B, VPN-C and VPN-D) and accommodates the user terminals (each terminal in the group A anc B) belonging to at least one of the plurality of VPNs. Then, the router 1 controls the routing and forwarding processes (VPN communications) of the packets between the group A and the ISP-A and between the group B and the ISP-B, and the routing and forwarding processes (inter-VPN communications) of the packets between the different VPNs. Each of the PM0, PM1 and PM3 respectively has two routing tables as shown in FIG. 1B.

<Composition of each PM>

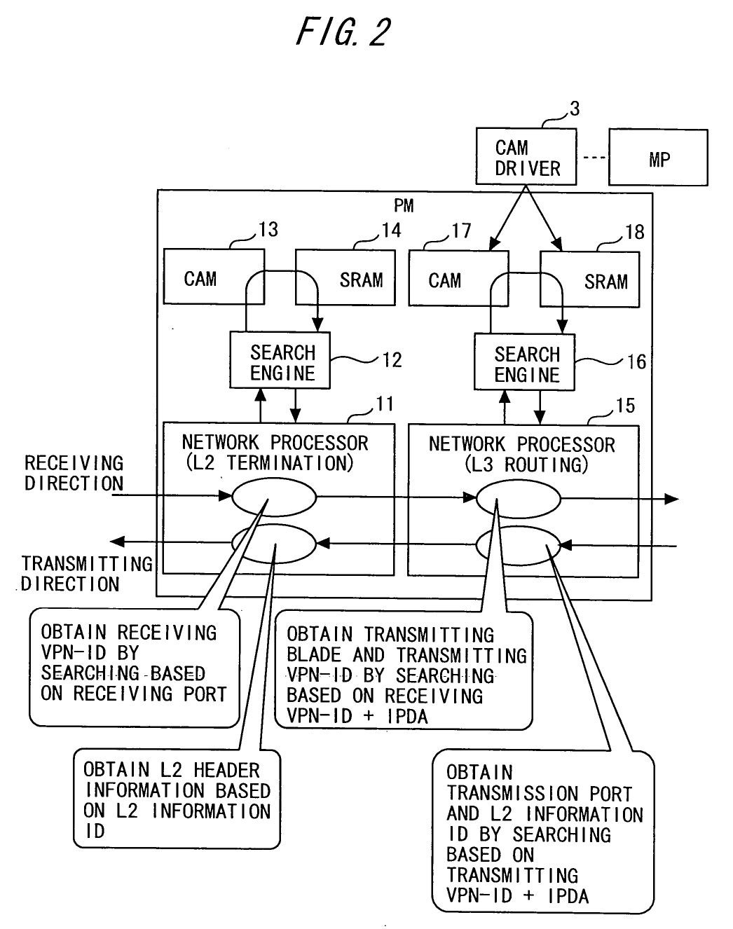

FIG. 2 is a diagram showing an example of composition of each PM shown in FIG. 1. Each of the PM0-PM2 has the same composition. Each of the PM0 PM2 functions as a receiving-side PM for receiving the packet from outside and as a transmitting-side PM for transmitting the packet received from the receiving-side PM to outside.

In FIG. 2, the PM includes an L2 processing unit that terminates a layer 2 (L2), and an L3 processing unit that performs routing to a layer 3 (L3). The L2 processing unit includes a network processor (NP) 11, a search engine (SE) 12, and a CAM 13 and an Static Random Access Memory (SRAM) 14 as a search table of the receiving-side VPN identifying information.

The NP 11 analyzes the packet and transfers search information obtained by the analysis to the SE 12. The SE 12 generates a CAM access key (a search key) on the basis of the search information from the NP 11, and makes a search of the CAM 13 by using the CAM access key. The SE 12 receives an address of the SRAM 14 from the CAM 13 as a search result. The SE 12 accesses the SRAM 14 by use of the SRAM address, and receives associative data (desired data) corresponding to the SRAM address. The SE 12 transfers the associative data to the NP 11.

In case the PM functions as the receiving-side PM, the L2 processing unit searches, from the search table, for the corresponding receiving-side VPN identifying information (the receiving-side VPN-ID), with a search key being the identifying information (an ID or a number) of a receipt port at which the packet was received, and transfers this receiving-side VPN-ID to the L3 processing unit. The receipt port of the packet can be identified by the analysis of the packet at the NP 11. Note that information other than the receipt port can be used as the search key for the receiving-side VPN-ID. Further, the receipt port and other information can be also used as a search key.

On the other hand, in case the PM functions as the transmitting-side PM, the L2 processing unit searches, from the search table, for a corresponding piece of L2 header information, with the search key being L2 header information received from the L3 processing unit. The L2 header is created based on the L2 header information searched for and added to the packet, and it is forwarded to a transmission port corresponding to a destination of the packet.

The L3 processing unit has substantially the same composition as the L2 processing unit. The L3 processing unit includes an NP 15 as a packet analyzing unit, a search engine (SE) 16 as a search unit, and a CAM 17 and a SRAM 18 as a routing table. The CAM 17 and the SRAM 18 construct a CAM device.

The L3 processing unit has substantially the same function as the L2 processing unit. The NP 15 analyzes the packet, and transfers search information obtained by the analysis to the SE 16. The SE 16 generates a CAM access key (a search key) on the basis of the search information from the NP 15, and makes a search of the CAM 17 by using the CAM access key. The SE 16 receives an address of the SRAM 18 from the CAM 17 as a search result. The SE 16 accesses the SRAM 18 by use of the SRAM address, and receives associative data (desired data) corresponding to the SRAM address. The SE 16 transfers the associative data to the NP 15.

In case the PM functions as the receiving-side PM, the L3 processing unit searches, from the search table, for the corresponding transmitting-side PM and transmitting-side VPN identifying information (the transmitting-side VPN-ID), with the search key being a receiving-side VPN-ID received from the L2 processing unit (the NP 11) and being an IP destination address (IPDA) of the packet that is obtained by analysis of the packet. The transmitting-side VPN-ID searched for is forwarded to the corresponding transmitting-side PM via the SW 2.

On the other hand, in case the PM functions as the transmitting-side PM, the L3 processing unit searches, from the search table, for corresponding pieces of identifying information (an ID or a number) of a transmission port and of L2 header information ID, with the search key being a transmitting-side VPN-ID received from the L3 processing unit of the receiving-side PM and being an IPDA of the packet, and transfers them to the L2 processing unit.

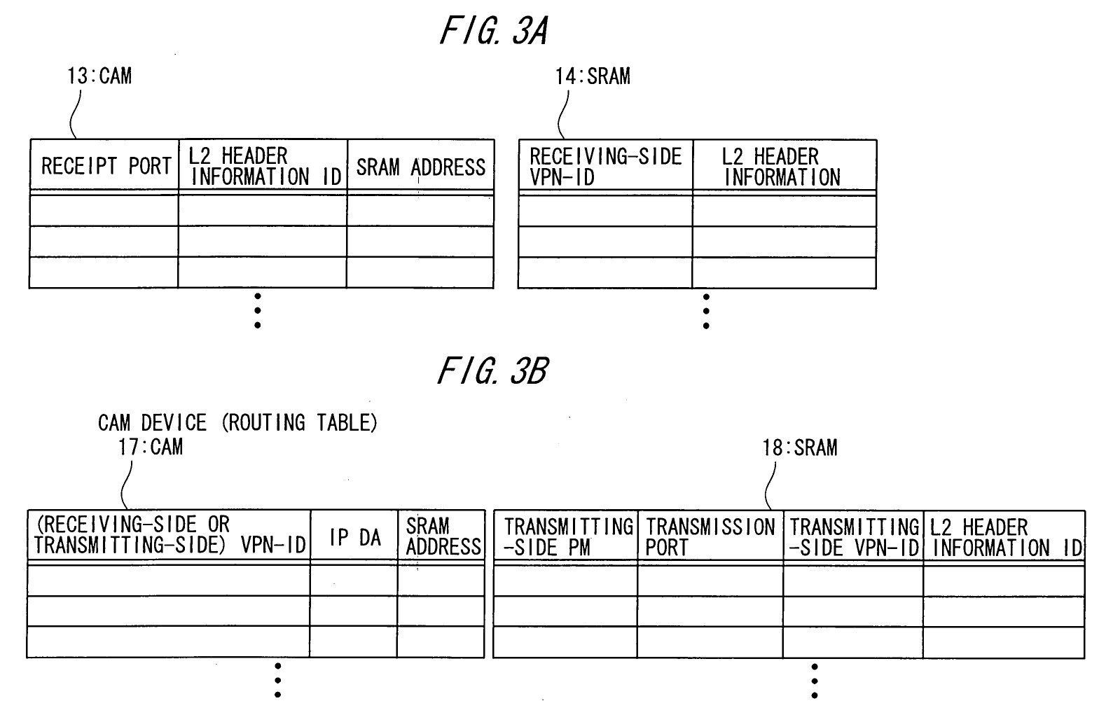

FIG. 3A is a diagram showing examples of data structures in the CAM 13 and in the SRAM 14 shown in FIG. 2, and FIG. 3B is a diagram showing examples of data structures in the CAM 17 and in the SRAM 18 shown in FIG. 2.

As shown in FIG. 3A, the CAM 13 is stored with one or more entries including the SRAM address corresponding to the receipt port identifying information or the L2 header information ID as a CAM access key. On the other hand, the SRAM 14 is stored with one or more entries including the receiving-side VPN-ID and the L2 header information as pieces of associative data.

Further, as shown in FIG. 3B, the CAM 17 is stored with one or more entries including the SRAM address corresponding to the receiving- or transmitting-side VPN-ID and the IPDA as the CAM access key. On the other hand, the SRAM 18 is stored with one or more entries including transmission PM identifying information (e.g. a blade number) as pieces of associative data, transmission port identifying information (e.g. a port number), a transmitting-side VPN-ID and L2 header information ID.

<Process by PM>

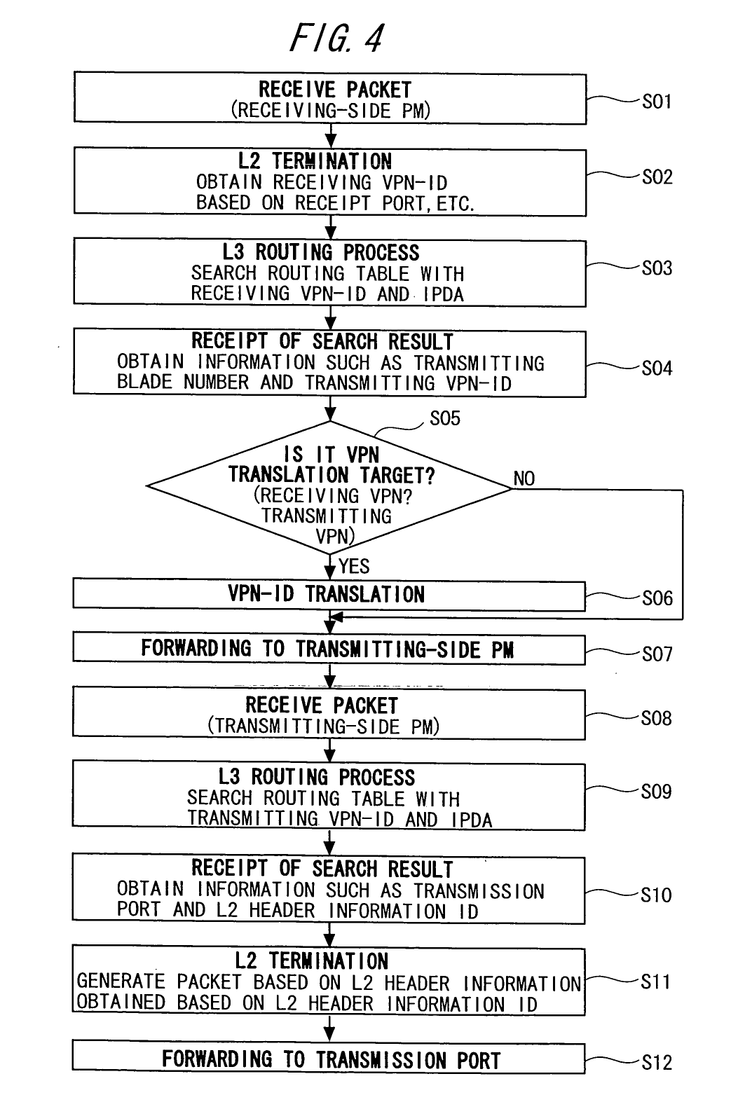

FIG. 4 is a flowchart showing a process (a VPN translation) by the receiving-side PM and the transmitting-side PM. In FIG. 4, when the receiving-side PM receives the packet (step S01), the NP 11 acquires the receiving-side VPN-ID on the basis of the receipt port as an L2 terminating process (step S02). Namely, the NP 11 of the L2 processing unit analyzes the packet and transfers the search information including receipt port identifying information (e.g. a receipt port number) to the SE 12. The SE 12 extracts the receipt port number from the search information, inputs this as a CAM access key to the CAM 13, and receives an SRAM address corresponding thereto from the CAM 13. The SE 12 reads, from the SRAM 14, a receiving-side VPN-ID stored in an SRAM address and transfers it to the NP 11. The NP 11 transfers the packet and the receiving-side VPN-ID to the NP 15 of the L3 processing unit.

Upon finishing step S02, the L3 processing unit performs a routing search by using the receiving-side VPN-ID and the IPDA as an L3 routing process (step S03). Namely, the NP 15 of the L3 processing unit analyzes the received packet, and transfers the search information including the receiving-side VPN-ID and the IPDA of the packet to the SE 16. The SE 16 extracts the receiving-side VPN-ID and the IPDA from the search information, inputs them as a CAM access key to the CAM 17, and receives an SRAM address corresponding thereto from the CAM 17. The SE 16 reads, from the SRAM 18, transmitting-side PM identifying information (e.g. a blade number) and a transmitting-side VPN-ID that are stored in the SRAM address.

The transmitting PM identifying information and the transmitting-side VPN-ID, which have been acquired by the SE 16, are transferred as a search result to the NP 15 (step S04).

Then, the NP 15 judges whether it is a VPN translation target or not (step S05). Namely, the NP 15 judges whether or not the receiving-side VPN-ID is different from the transmitting-side VPN-ID. At this time, if the VPN-IDs are different from each other (S05: YES), the processing proceeds to step S06, and, whereas if not (S05; NO), the processing proceeds to step S07.

In case the processing proceeds to step S06, the NP 15 executes a VPN-ID translation process. That is, the NP 15 translates a value of the receiving-side VPN-ID into a value of the transmitting-side VPN-ID. Thereafter, the processing proceeds to step S07.

In case the processing proceeds to step S07, the NP 15 forwards the packet and the transmitting-side VPN-ID to the transmitting-side PM searched for.

Herein, the process in step S06 implies a process of translating the value of the transmission target VPN-ID into the value of the transmitting-side VPN-ID. According to this, even in the case of such a composition (a conventional composition) that the receiving-side PM forwards the receiving-side VPN-ID to the transmitting-side PM, the transmitting-side VPN-ID searched for can be forwarded to the transmitting-side PM. On the other hand, in case the receiving-side VPN-ID is equal to the transmitting-side VPN-ID, the receiving-side VPN-ID is forwarded to the transmitting-side PM, whereby it follows that the transmitting VPN-ID is to be forwarded. Thus, the present invention can be actualized by improving the entry structure in the routing table and inserting steps S05 and S06 into the conventional processing steps. The invention may, however, be configured so that a VPN-ID having the equal value to the transmitting-side VPN-ID retrieved from the routing table of the receiving-side PM is forwarded as the search key to the transmitting-side PM, and may also be configured so that the transmitting-side VPN-ID searched for is forwarded to the transmitting-side PM.

The packet and the transmitting-side VPN-ID sent from the receiving-side PM arrive, based on the transmitting-side PM identifying information searched for, at the corresponding transmitting-side PM via the SW 2 (step S08).

Then, the L3 processing unit of the transmitting-side PM executes, as the L3 routing process, a routing search based on the transmitting-side VPN-ID and the IPDA (step S09). Namely, the NP 15 of the transmitting-side PM analyzes the packet, and transfers the search information including the transmitting-side VPN-ID and the IPDA to the SE 16. The SE 16 extracts the transmitting-side VPN-ID and the IPDA from the search information, inputs them as the CAM access key to the CAM 17, and receives the SRAM address corresponding thereto from the CAM 17. The SE 16 accesses the SRAM 18, and reads the transmission port identifying information (e.g. the transmission port number) and the L2 header information ID that are stored in the SRAM address.

The transmission port number and the L2 header information ID acquired by the SE 16 are transferred as a search result to the NP 15 (step S10). The NP 15 transfers the search result together with the packet to the L2 processing unit.

The L2 processing unit executes an L2 termination process (step S11). Namely, the NP 11 transfers the L2 header information ID to the SE 12. The SE 12 inputs the L2 header information ID as the CAM access key to the CAM 13, acquires a SRAM address corresponding thereto, acquires from the SRAM 14 the L2 header information stored in the SRAM address, and transfers it to the NP 11. The NP 11 generates a L2 header based on the L2 header information and adds the L2 header to the packet.

Then, the NP 11 forwards the packet to the transmission port corresponding to the transmission port number searched for (step S12)

In the router 1, the routing entries (the entries for the networks) for searching for the network address as shown in FIG. 1 and the routing entries (the entries for the terminals) for searching the terminals, are registered in the routing table (the CAM 17 and the SRAM 18) with respect to each of PM0, PM1 and PM2.

Herein, as described above, the receiving-side PM searches for the transmitting-side PM by use of the receiving-side VPN-ID, and the transmitting-side PM searches for the transmission port corresponding to the destination of the packet by use of the transmitting-side VPN-ID. This enables, though the VPN (the transmitting-side VPN-ID) to which the destination of the packet belongs is the same, even in the case where the VPN (the receiving-side VPN-ID) to which the transmission source belongs is different, the transmitting-side PM to perform the routing search by use of the same entries.

In particular, the router 1 has the plurality of terminals belonging to the same VPN. Therefore, the router 1 is constructed so as to determine the transmission port by identifying the terminal corresponding to the destination of the packet (the routing table for the terminals (the entries for the terminals) is prepared). Therefore, the access-side PM (PM1, PM2) functioning as the transmitting-side PM determines the transmission port by identifying the VPN to which the terminal belongs and the terminal (i.e., the IPDA (the destination address) of the packet). At this time, the access-side PM, because of using the transmitting-side VPN-ID, even when the transmission source of the forwarding target packet belongs to any one of the VPN-A, VPN-B, VPN-C and VPN-D, can determine the transmission port by use of the same entries.

Thus, in the embodiment, there is no necessity of preparing the entries for every receiving-side VPN-ID and every host address in order to identify the terminal in the router 1. Accordingly, the number of the CAM entries can be reduced, and the entry registration in the CAM can be efficiently conducted.

Note that the SE 16 of each PM is constructed so as to, in the routing search, generate a combination (which is a CAM access key to the entries for the networks) of the VPN-ID and the network address and a combination (which is a CAM access key to the entries for the terminals) of the VPN-ID and the host address, and to input them to the CAM 17. With respect to a packet flow of the access side—> the up-link side, however, each of the receiving-side and transmitting-side PMs may be constructed so as to generate only the CAM access key to the entries for the networks. Further, with respect to the packet flow of the up-link side—> the access side, the receiving-side PM may be constructed so as to generate only the CAM access key to the network entries, and the transmitting-side PM may also be constructed so as to generate only the CAM access key to the entries for the terminals.

<Entry Registration>

Next, a process on the occasion of registering routing entries (which will hereinafter be simply termed “entries”) will be explained. As shown in FIG. 1, in the case of registering the entries in the routing table, there is constructed so that a plurality of entries as candidates for registration are distributed to each PM by a registration command from a main processor (MP) connected to the router 1.

To explain it concretely, the MP gives the router 1 the plurality of entries as the candidates for registration that should be registered in the CAM 17 and the SRAM 18 (i.e., a CAM device, namely the routing table), as shown in FIG. 1, of each PM. The plurality of entries given to the router 1 are given respectively to a CAM driver (corresponding to entry registration means) provided per PM in the router 1, and written to (registered in) the corresponding CAM 17 and SRAM 18.

Herein, the plurality of entries includes the entries for the networks and the entries for the terminals. Each entry for the networks includes, as shown in FIG. 1, a receiving-side or transmitting-side VPN-ID and a network address as pieces of CAM entry information (a CAM access key), and includes, as pieces of SRAM associative data information, transmitting-side PM identifying information (e.g. a blade number), a transmission (output) port number and a transmitting-side VPN-ID.

On the other hand, each entry for the terminals includes a receiving-side or transmitting-side VPN-ID and a host address of the terminal as pieces of CAM entry information, and includes transmitting-side PM identifying information (e.g. a blade number), a transmission port number and a transmitting-side VPN-ID as pieces of SRAM associative data information. Note that the L2 header information ID is omitted in FIG. 1. Namely, the L2 header information ID is not an indispensable piece of information element for the invention.

Herein, the plurality of entries as the candidates for registration are entries with respect to all combinations of the VPN-ID, the network address and the host address of the terminal in connection with the routing process of the router 1, and the entries for the terminals includes one or more overlapped entries (see FIG. 1). Then, the CAM driver of each PM executes an entry delete process, thereby deleting one or more unnecessary (registered but non-used) entries.

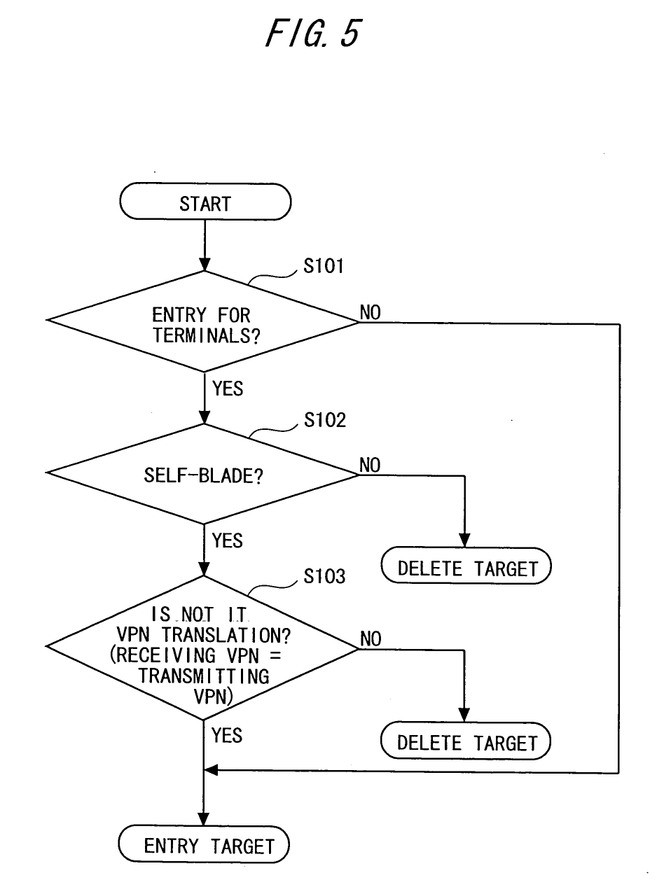

FIG. 5 shows a flowchart of the entry delete process. Each CAM driver 3 executes the entry delete process for every entry in a way that sets all the entries related to the registration command as processing targets.

At first, the CAM driver 3 judges whether a processing target entry is the entry for the terminals or not (step S101). At this time, if the entry is not the entry for the terminals (but the entry for the networks) (S101; NO), the CAM driver 3 registers this entry as a registration target in the CAM 17 and in the SRAM 18.

Whereas if the entry is the entry for the terminals (S101; YES), the CAM driver 3 refers to the blade number contained in this entry and judges whether this blade number is a self-blade number or not (step S102). The CAM driver 3 previously knows the blade number of the PM corresponding to the driver itself. Herein, if the blade number is not the self-blade number (S102; NO), the CAM driver 3 sets this entry as a delete target and performs no registration (discarding) of this entry.

Whereas if the blade number is the self-blade number (S102; YES), the CAM driver 3 judges whether or not the entry is a translation target, namely, judges whether the receiving VPN-ID (the VPN-ID contained in the CAM entry information) and the transmitting VPN-ID, which are contained in the entry, are equal or not (step S103).

At this time, if the VPN-IDs are different from each other (S103; NO), the CAM driver 3 sets this entry as a delete target and performs no registration (discarding) of this entry.

Whereas if the VPN-IDs are equal to each other (S103; YES), the CAM driver 3 sets this entry as a registration target and registers this entry in the CAM 17 and in the SRAM 18.

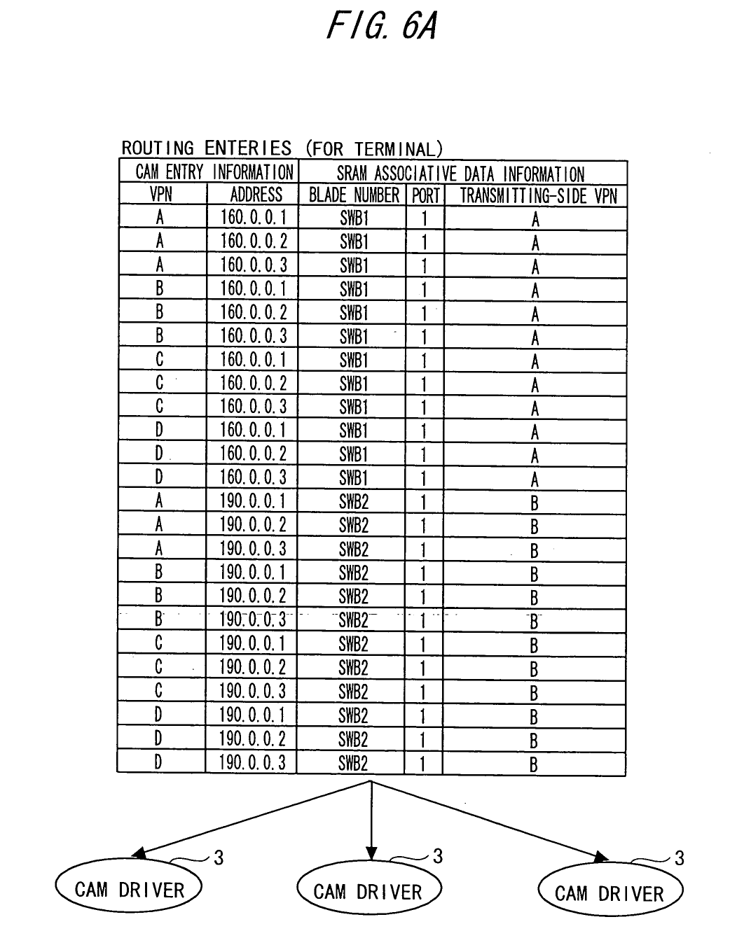

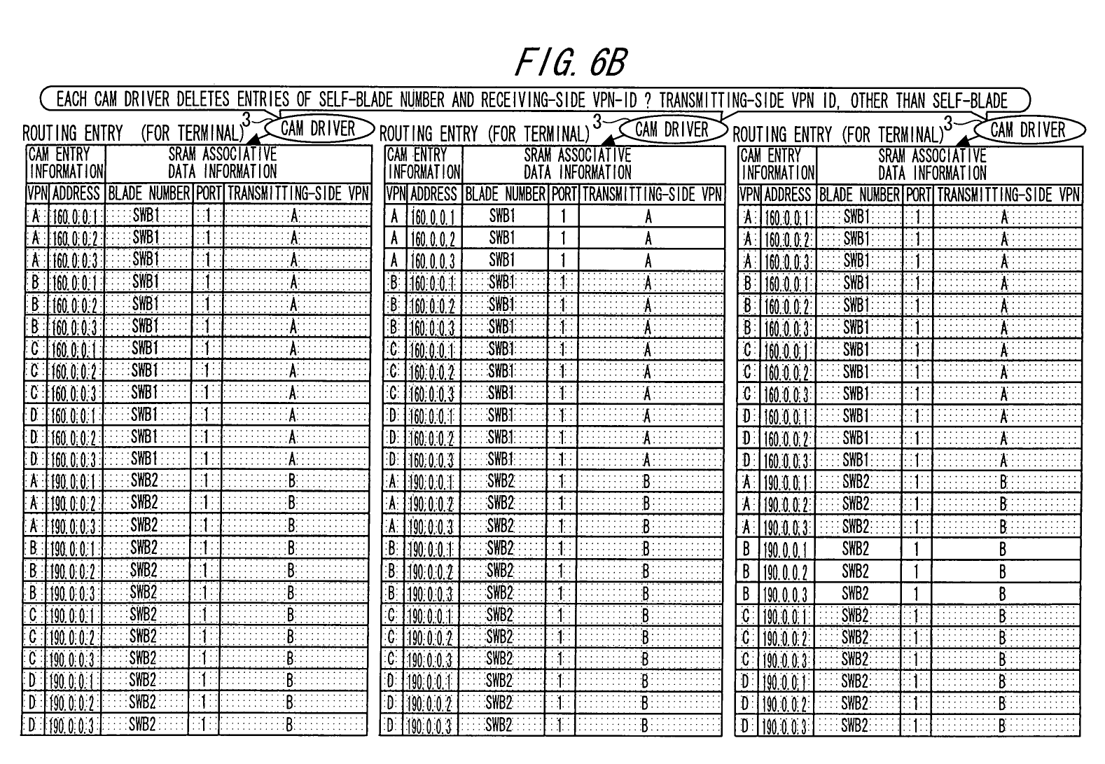

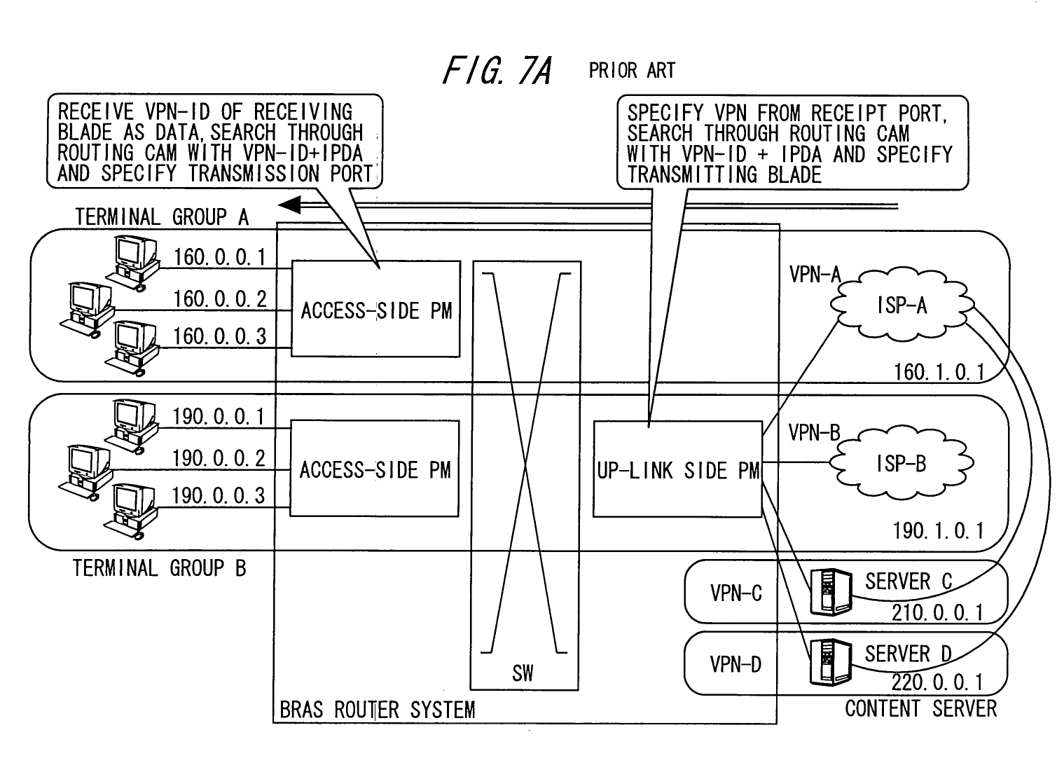

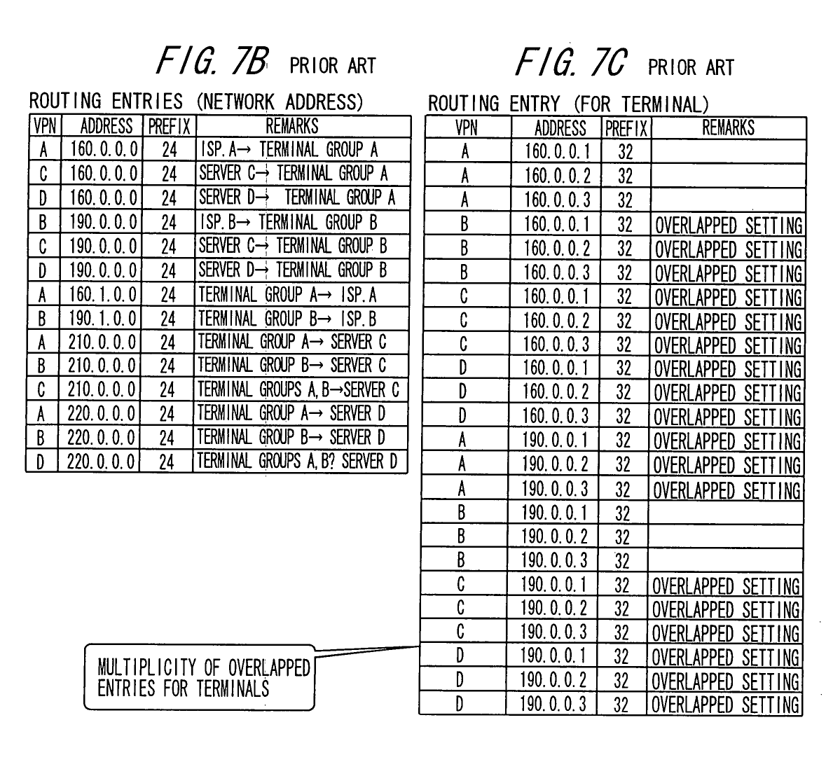

Each CAM driver 3 corresponding to each of the PMs (PM0-PM2) individually effects the entry delete process. The entry for the terminals, which is not used in each of the PM0-PM2, is thereby, as shown in FIG. 6, deleted from the plurality of entries based on the registration command from the MP.

A state in an example shown in FIGS. 6A and 6B are that among the plurality of PMs, the entries for the terminals are registered in only in the routing table of the access-side PM accommodating at least one of terminal, the routing table of each access-side PM is registered with only the entries for the terminals related to the VPN to which the terminals accommodated in the access-side PM.

Accordingly, the number of the registration entries can be reduced, an effective utilization of a storage space of the CAM device can be made. Note that the CAM driver 3 may delete the entries, which have been temporarily registered in the CAM and the SRAM, from the CAM and the SRAM by the above-mentioned process.

According to the embodiment, it is possible to delete the overlapped entry and the unused entry among the entries for the terminals of the BRAS performing the inter-VPN communications, and hence, even in a case where there increase the common servers such as the content servers for services as the BRAS, the overlapped entry is not required to be registered, and the efficient entry registration by the CAM device becomes possible. Further, the system enables a deletion of the entry for performing the inter-VPN communications in normal packet forwarding routing entries as well as in the entries of the BRAS, whereby the efficient entry becomes possible.

According to the invention, the overlapped entry does not need to be registered, and the efficient entry registration becomes possible.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A packet routing device accommodating a plurality of virtual private networks (VPNs), comprising:
a switch; and
a plurality of packet processing units each having a routing table,
wherein each packet processing unit, in the case of receiving a packet received at a receipt port, searches, as a receiving-side packet processing unit, for a transmitting-side packet processing unit for forwarding the packet to a transmission port from the routing table by use of a receiving-side VPN identifier of the packet, and forwards the packet to a packet processing unit corresponding to the transmitting-side packet processing unit, and,
in the case of receiving a packet via the switch from a receiving-side packet processing unit, searches, as a transmitting-side packet processing unit, for a transmission port for the packet from the routing table by use of a transmitting-side VPN identifier of the packet, and forwards the packet to the transmission port searched for.

2. A packet routing device according to claim 1, wherein each of the packet processing units, in the case of functioning as the receiving-side packet processing unit, searches for a corresponding transmitting-side packet processing unit and a transmitting-side VPN identifier from the routing table by use of the receiving-side VPN identifier, and forwards the searched transmitting-side VPN identifier to a transmitting-side packet processing unit, and,
in the case of functioning as the transmitting-side packet processing unit, searches for a corresponding transmission port from the routing table by use of the transmitting-side VPN identifier from the receiving-side packet processing unit.

3. A packet routing device according to claim 2, wherein each of the packet processing units as a receiving-side packet processing unit, in case a receiving-side VPN identifier is the same as a transmitting-side VPN identifier searched for, forwards a transmitting-side VPN identifier having an equal value to the receiving-side VPN identifier, to a transmitting-side packet processing unit.

4. A packet routing device according to claim 2, wherein each of the packet processing units, in the case of functioning as a receiving-side packet processing unit, searches for a VPN identifier, as a receiving-side VPN identifier, corresponding to a receipt port of a packet.

5. A packet routing device according to claim 3, wherein each of the packet processing units, in the case of functioning as a receiving-side packet processing unit, searches for a VPN identifier, as a receiving-side VPN identifier, corresponding to a receipt port of a packet.

6. A packet routing device according to claim 1, further comprises entry registering means for executing a process of registering one or more entries in the routing table of each packet processing unit, wherein the entry registering means receives a plurality of entries as candidates for registration with respect to a certain packet processing unit, each entry includes a VPN identifier as a search key, and packet processing unit identifying information and a transmitting-side VPN identifier corresponding to the VPN identifier as the search key, the entry registering means executes a process for registering in the routing table only one or more entries that, among the plurality of entries as the candidates for registration, the packet processing unit identifying information included in the entry indicates the certain packet processing unit, and that the VPN identifier as the′ search key is the same as the transmitting-side VPN identifier.

7. A packet routing device disposed between a network side and a user side, accommodating a plurality of virtual private networks (VPNs), and accommodating a user terminal belonging to any one of the VPNs, comprising:
a switch; and
a plurality of packet processing units each having a routing table,
wherein each packet processing unit, in the case of receiving a packet received at a receipt port and addressed to a user terminal, searches, as a receiving-side packet processing unit, for a transmitting-side packet processing unit and a transmitting-side VPN identifier corresponding to a receiving-side VPN identifier and a destination network address of the packet from a routing table, and,
in the case of receiving a packet and a transmitting-side VPN identifier from a receiving-side packet processing unit via the switch, searches, as a transmitting-side packet processing unit, for a transmission port corresponding to the transmitting-side VPN identifier and to a destination host address of the packet from the routing table, and forwards the packet to the transmission port searched for.

8. A packet processing device provided in a packet routing device accommodating a plurality of virtual private networks (VPNs) with at least one other packet processing device, comprising:
a receiving-side packet processing unit;
a transmitting-side packet processing unit; and
a routing table,
wherein the receiving-side packet processing unit receives a packet received at a receipt port of the packet routing device and searches for other packet processing device for forwarding the packet to a transmission port from the routing table by use of a receiving-side VPN identifier of the packet, and
the transmitting-side packet processing unit receives a packet forwarded from other packet processing device and searches for a transmission port of the packet from the routing table by use of a transmitting-side VPN identifier of the packet.
